(19) United States
(12) Patent Application Publication
(10) Pub. No.: US 2016/0214598 A1
(43) Pub. Date: Jul. 28, 2016

(54) DRIVING FORCE CONTROL SYSTEM FOR A VEHICLE

(71) Applicant: TOYOTA JIDOSHA KABUSHIKI KAISHA, Toyota-shi, Aichi (JP)

(72) Inventors: Atsushi TABATA, Toyota-shi (JP); Toshiki KANADA, Toyota-shi (JP); Tatsuya IMAMURA, Toyota-shi (JP); Tooru MATSUBARA, Toyota-shi (JP); Shunya KATO, Toyota-shi (JP); Kenta KUMAZAKI, Toyota-shi (JP)

(73) Assignee: TOYOTA JIDOSHA KABUSHIKI KAISHA, Toyota-shi, Aichi-ken (JP)

(21) Appl. No.: 14/917,130

(22) PCT Filed: Aug. 27, 2014
(86) PCT No.: PCT/JP2014/073112

§ 371 Date: Mar. 7, 2016

(30) Foreign Application Priority Data
Sep. 6, 2013 (JP) 2013-184907

(51) Int. Cl. B60W 20/10; B60W 10/08; B60W 20/40; B60K 6/445; B60K 6/365; B60K 6/387; B60W 10/06; B60W 10/02

(52) U.S. Cl. CPC B60W 20/10; B60W 10/06; B60W 10/08; B60W 10/02; B60K 6/445; B60K 6/365; B60K 6/387; B60W 20/40; B60W 2710/0666; B60W 2710/083; B60W 2710/021; Y10S 903/93; Y10S 903/91; Y10S 903/914; B60Y 2200/92

(57) ABSTRACT

A driving force control system for improving energy efficiency under a motor-drive mode. The control system selects the motor-drive mode from a single motor-mode where a vehicle is powered by any one of the rotary devices, and a dual motor-mode where the vehicle is powered by both rotary devices. The driving force control system is configured to select the single-motor mode rather than the dual-motor mode, provided that an increment of an energy consumption to establish the dual-motor mode is larger than a decrement of the energy consumption to be achieved by the dual-moor mode, under a driving condition where a required driving force can be achieved by either the single-motor mode or the dual-motor mode.

### TECHNICAL FIELD

This invention relates to a driving force control system for a vehicle in which a prime mover for generating a driving force is comprised of at least two torque generating devices.

### BACKGROUND ART

In the prior art, various kinds of control systems and methods have been proposed for a hybrid vehicle having a motor serving as a prime mover. More specifically, control systems and methods for efficiently regenerating inertial energy of the vehicle by the motor have been proposed. For example, Japanese Patent Laid-Open No. 2008-265600 discloses a hybrid vehicle comprised of an engine and two motors. The vehicle disclosed therein is allowed to be powered by those motors while halting a rotation of the engine by a clutch. According to the control method taught by Japanese Patent Laid-Open No. 2008-265600, the vehicle is powered by the motor in an optimally fuel efficient manner while halting a rotation of the engine by the clutch upon satisfaction of a predetermined condition. For instance, the predetermined condition is satisfied provided that a state of charge of an electric storage device is larger than a predetermined value, that an opening degree of an accelerator is wider than a predetermined value, that a reverse position is selected, or that the vehicle is not allowed to be powered by the engine.

Thus, the vehicle having a motor is powered by the motor under the condition that the state of charge of the electric storage device is sufficient, and the motor can establish the demanded driving force. In such situation, according to the teachings of Japanese Patent Laid-Open No. 2008-265600, the motors are individually driven in an optimally energy efficient manner. However, in the vehicle disclosed therein, the energy has to be consumed to engage the clutch in order to power the vehicle by the motors. That is, an energy loss occurs inevitably as a result of consuming the energy to engage the clutch thereby allowing the vehicle to be powered by the motor. Thus, although the invention taught by Japanese Patent Laid-Open No. 2008-265600 focuses on the energy efficiency of the motor to be driven for driving the vehicle, it does not focus on the energy consumption and the power loss resulting from driving the vehicle by the motor. Therefore, fuel efficiency and electricity efficiency may not be improved sufficiently.

The present invention has been conceived noting the foregoing technical problems, and it is an object of this invention to provide a driving force control system for improving the energy efficiency by selecting a driving mode taking into consideration the energy consumption or energy loss resulting from driving a vehicle by a power of a torque generating rotary device such as a motor.

### DISCLOSURE OF INVENTION

A driving force control system of the present invention is applied to a vehicle having at least two torque generating rotary devices serving as a prime mover, and in the vehicle, a single motor-mode and a dual motor-mode can be selected by the driving force control system. Under the single motor-mode, the vehicle is propelled by a power of any one of the rotary devices, and under the dual motor-mode, the vehicle is propelled by powers of both of the rotary devices. In order to achieve the above-explained object, the driving force control system is configured to select the single-motor mode rather than the dual-motor mode provided that an increment of an energy consumption to establish the dual-motor mode is larger than a decrement of the energy consumption to be achieved by propelling the vehicle under the dual-moor mode, under a driving condition where a required driving force can be achieved by either the single-motor mode or the dual-motor mode.

The driving force control system may be applied to the vehicle comprised of a power distribution device adapted to perform a differential action at least among a first rotary element, a second rotary element to which a torque of a first rotary device of the two torque generating rotary devices is inputted, and a third rotary element serving as an output element to which a torque of a second rotary device of the two torque generating rotary devices is inputted. In this case, the vehicle is propelled by a power generated by the second rotary device under the single-motor mode.

The driving force control system is further comprised of an engagement device that is engaged to establish the dual-motor mode. Accordingly, the increment of the energy consumption to establish the dual-motor mode includes an energy consumed to engage the engagement device.

The prime mover is further comprised of an engine, and a rotation of the engine may be halted by engaging the engagement device.

The power distribution device is lubricated by lubricant, and viscosity of the lubricant is changed depending on a temperature. Accordingly, the increment of the energy consumption to establish the dual-motor mode includes an amount of energy loss resulting from a reduction in a torque of the first rotary device occurs in the torque distribution device, in addition to the energy consumed to engage the engagement device.

The first rotary device is connected with an output shaft for delivering the torque to driving wheels, the second rotary device is connected with the first rotary device through the engagement device, and the engine is connected with the second rotary device through a clutch.

For example, a motor or a motor-generator may be used as the torque generating rotary device, and a hydraulically or electromagnetically engaged friction clutch or a dog clutch may be used as the engagement device.

Thus, according to the present invention, a power unit that can contribute to improve the energy efficiency such as a motor and a motor-generator are used as the torque generating rotary device, and the driving mode for propelling the vehicle by the rotary device(s) is selected if the driving condition governed by a vehicle speed and a required driving force falls within a predetermined operating region. In this case, the driving mode is selected from a single-moor mode for propelling the vehicle by any one of the rotary device, and a dual-motor mode for driving the vehicle by both of the rotary devices. However, the required driving force may be achieved by both of the single-motor mode and the dual-motor mode depending on the driving condition. Under the single-motor mode, the required driving force is achieved only by one of the rotary device, therefore, an output torque and a rotary speed thereof has to be increased. In contrast, under the dual-motor mode, the required driving force is achieved using both of the rotary device so that the output torque and rotary speed of each rotary device may be reduced individually in comparison with those under the single-motor mode. That is, in terms of the rotary devices, the energy efficiency can be improved by selecting the dual-moor mode in most cases, rather than selecting the single-motor mode. Such reduction amount of the energy corresponds to the decrement of the energy consumption of the present invention. Meanwhile, the energy has to be consumed by engaging the engagement device to establish the dual-motor mode. Accordingly, such energy consumption to engage the engagement device corresponds to the increment of the energy consumption of the present invention.

According to the present invention, if the increment of the energy consumption exceeds the decrement of the energy consumption, the single-motor mode is selected instead of the dual-motor mode. Thus, unlike the conventional art, the energy consumption to engage the engagement device is considered as a power loss to judge the energy efficiency of each driving mode, and the driving mode possible to achieve better energy consumption is selected. According to the present invention, therefore, the energy efficiency, as well as the fuel and electric economy can be improved under the condition that the vehicle is propelled without using the engine.

Especially, under the dual-motor mode, a friction loss of the power of the first rotary device occurs in the power distribution device is also considered as the increment of the energy consumption. According to the present invention, therefore, deterioration in the energy efficiency resulting from selecting the dual-motor mode can be reduced.

### BRIEF DESCRIPTION OF DRAWINGS

FIG. 1 is a flowchart showing one example of the control to be carried out by the control system of the present invention.

FIG. 2 is a graph schematically showing a relation between an output of a first motor-generator and a fixed energy for engaging a brake.

FIG. 3 is a graph schematically showing a relation between an oil temperature and a drag loss.

FIG. 4 is a block diagram schematically showing one example of a power train of the hybrid vehicle to which the present invention is applied.

FIG. 5 is a map determining regions of engine mode, two-motor mode, and single-motor mode.

FIG. 6 is a skeleton diagram schematically showing another example of the power train of the hybrid vehicle to which the present invention is applied.

FIG. 7 is a block diagram schematically showing a control system according to the present invention.

FIG. 8 is a nomographic diagram showing a state of a power distribution device shown in FIG. 6 under the condition that the vehicle is powered by the engine.

FIG. 9 is a nomographic diagram showing a state of the power distribution device shown in FIG. 6 under the condition that the vehicle is powered by the motor-generator.

FIG. 10 is a skeleton diagram schematically showing an example of the power train in which a transmission is disposed between the engine and the power distribution device.

FIG. 11 is a table showing states of a clutch, brake and motor-generators under each driving mode.

FIG. 12 is a nomographic diagram showing states of the power distribution device and the transmission shown in FIG. 10 under the condition that the vehicle is powered by the engine.

FIG. 13 is a nomographic diagram showing states of the power distribution device and the transmission shown in FIG. 10 under the condition that the vehicle is powered by the motor-generator.

### BEST MODE FOR CARRYING OUT THE INVENTION

The driving force control system of the present invention is applied to a vehicle in which a prime mover is comprised of an engine and at least two torque generating rotary devices. In the vehicle of this kind, an internal combustion engine such as a gasoline engine and a diesel engine may be used as the engine. Specifically, the “torque generating rotary device” is a power unit that is rotated by the energy to generate a torque. Accordingly, the torque generating rotary device includes a motor, a motor-generator, and a flywheel rotated by a regenerative energy (the motor-generator may simply be called the “motor”). That is, the driving force control system of the present invention is applied to a hybrid vehicle comprised of at least two motors. In the hybrid vehicle of this kind, for example, one of the motors is used to control a rotational speed and a torque of the engine, and the other motor is used to generate a driving force. In addition, the driving force control system of the present invention may be applied to any types of hybrid vehicles such as a series hybrid vehicle, a parallel hybrid vehicle and a series/parallel hybrid vehicle.

The hybrid vehicle to which the driving force control system is applied may be powered not only by the engine but also by the motor. Under the driving mode for propelling the vehicle by the engine power, the engine power is partially delivered to driving wheels while operating the first-motor-generator by the remaining power to generate an electric power for operating the second motor-generator. In this case, alternatively, the engine power may also be used to operate a generator to operate the motor by the generated electric power. Meanwhile, the driving mode for propelling the vehicle by the electric power may be established by operating not only one of the motors but also both of the motors by delivering the electric power thereto from a battery.

Referring in more detail to the drawings, FIG. 4 shows one example of a powertrain of the hybrid vehicle. In the preferred example shown in FIG. 4, an engine (ENG) 1 and two motor-generators (MG1, MG2) 2, 3 are arranged in tandem. Specifically, an output shaft (i.e., a crankshaft) of the engine 1 is connected to a rotor of the first motor-generator (MG1) 2 through a first clutch C1, and the rotor of the first motor-generator (MG1) 2 is connected to a rotor of the second motor-generator (MG2) 3 through a second clutch C2. The rotor of the second motor-generator (MG2) 3 is connected to an output shaft 4A for derivering a torque to driving wheels 4. A fuel delivery amount to the engine 1, an ignition timing, an opening degree of a throttle valve, a timing to open/close valves etc. are controlled electrically. Although not especially shown, the motor-generators 2 and 3 are individually connected to a battery through an inverter so that a rotational speed and a torque thereof are controlled electrically, and that the motor-generators 2 and 3 are switched electrically between a motor and a generator. In addition, activation and a torque transmitting capacity of each clutch C1 and C2 are also controlled electrically. To this end, the engine 1, and the motor-generators 2 and 3 are individually connected to an electronic control unit (abbreviated as ECU hereinafter).

Thus, the prime mover is comprised of the engine 1 and the motor-generators 2 and 3, and a power range and output characteristics of each power unit differ from one another. For example, a torque range and a speed range of the engine 1 are widest in those power units, and an energy efficiency thereof is optimized in a higher range. In turn, the first motor generator 2 is used to control a speed of the engine 1 and a crank angle for stopping the engine 1. To this end, the first motor generator 2 is adapted to output large torque in a low speed region. Meanwhile, the second motor-generator 3 is used to apply torque to the driving wheels 4. To this end, the second motor-generator 3 is allowed to be rotated at higher speed than the first motor generator 2, and a maximum torque of the second motor-generator 3 is smaller than that of the first motor generator 2. Therefore, the control system of the present invention is configured to improve the energy efficiency and the fuel economy by efficiently controlling the prime mover such as the engine 1 and the motor-generators 2 and 3.

In the preferred example, a driving mode of the vehicle is selected from engine mode where the vehicle is propelled by a power of the engine 1, dual-motor mode where the vehicle is propelled by operating both of the motor-generators 2 and 3 as motors, and a single-motor mode where the vehicle is propelled by a power of any one of motor-generators 2 and 3 (specifically, by the second motor-generator 3). Operating regions of those driving modes are schematically shown in FIG. 5 where a horizontal axis represents a vehicle speed V and a longitudinal axis represents a required driving force F As can be seen from FIG. 5, the region I represents a single-motor region where the single-motor mode is selected. The region II represents a dual-motor region where the dual-motor mode is selected based on the vehicle speed V and the required driving force F, but the vehicle is also allowed to be propelled only by the second motor-generator 3. In turn, the region III represents a dual-motor requiring region where the dual-motor mode has to be selected to achieve the required driving force F by operating both of the motor-generators 2 and 3. Meanwhile, the region IV represents an engine region where the engine mode is selected.

Those regions are determined in a manner such that the required driving force F can be achieved in an optimally energy efficient manner. The energy efficiency is deteriorated as a result of an increase in energy consumption. For example, provided that the driving force is increased, torques applied to the clutches C1 and C2 are increased and greater energies are required for engaging the clutches C1 and C2. Meanwhile, provided that the vehicle speed is increased, greater energy is required for driving the oil pump to deliver a larger amount of the oil for the lubrication purpose. In addition, provided that an oil temperature is low and viscosity of the oil is high, larger energy is also required for driving the oil pump. By contrast, the energy efficiency is improved in the following cases. For example, under the dual-motor mode, an electrical loss can be reduced by optimizing a proportion to establish torques by the motor-generators 2 and 3 so that the energy efficiency is improved in comparison with that under the single-motor mode. Therefore, the above-explained operating regions are determined taking into consideration such augmentation and reduction in the energy efficiency. That is, if the energy consumption resulting from engaging the clutch C2 is expected to be larger than a reduction in the energy loss to be achieved by the dual-motor mode, the single-motor mode is selected.

Each motor-generators 2 and 3 is individually adapted to generate a maximum torque at a low speed (i.e., at a low vehicle speed), and the output torque thereof is reduced with an increase in the speed at a speed higher than a predetermined speed (i.e., a predetermined vehicle speed). Accordingly, a contour of a boundary line between the motor region and the engine region is similar to that of a characteristic line of each motor-generator 2 and 3. Preferably, a high-speed/low-torque type motor is used as the second motor-generator 3. In this case, a contour of a boundary line between the single-motor region I and the dual-motor region II is similar to the characteristic line of the second motor-generator 3.

For example, as the case of controlling the engine and the motor-generator(s) in the conventional hybrid vehicle, the required driving force F is calculated based on an opening degree of an accelerator and a vehicle speed. Here, the calculation value of the driving force may be adjusted depending on a grade or a class of the vehicle to achieve a required drive performance and drive characteristics. In this preferred example, any of the required driving force F the opening degree of the accelerator, and a parameter determined based on those factors may be employed as a target power.

According to the preferred example, therefore, the engine mode is selected provided that the opening degree of the accelerator is larger than a predetermined angle, or that the vehicle speed is higher than a predetermined speed. Under the engine mode, specifically, the engine 1 is operated in a manner to achieve the required driving force F, and both of the clutches C1 and C2 are engaged to deliver torque generated by the engine 1 to the driving wheels 4 through the motor-generators 2 and 3. In this situation, the torque and the rotational speed of the engine 1 is controlled e.g., by the first motor-generator 2, and if an electric power is generated by the first motor-generator 2 in consequence, the second motor-generator 3 is operated by the electric power thus generated. Accordingly, the engine mode also may be called a hybrid mode.

By contrast, if the opening degree of the accelerator is small and the required driving force is therefore small, the vehicle is driven within the single-motor region I. In this case, the engine 1 is stopped and at least the second clutch C2 is disengaged. In this situation, the second motor-generator 3 is operated as a motor by supplying the electric power from the battery so that the vehicle is propelled by the second motor-generator 3. Optionally, the crank angle may be adjusted by the first motor-generator 2 to a suitable angle for restarting the engine 1.

If the required driving force F is increased to exceed the single-motor region I, the vehicle is driven within the dual-motor region II. In this case, the engine 1 is also stopped, the first clutch C1 is disengaged and the second clutch C2 is engaged. In this situation, both of the motor-generators 2 and 3 are operated as motors by supplying the electric power thereto from the battery. If the required driving force F is further increased to exceed the dual-motor region II, the vehicle is driven within the dual-motor requiring region III, and the above-explained control for the dual-motor region II is also carried out. In addition, the single-motor mode and the dual-motor mode are permitted to be selected under the conditions that a state of charge (abbreviated as SOC hereinafter) of the battery is sufficient, that the second motor-generator 3 is in condition to generate torque, and that the engine 1 is allowed to be stopped.

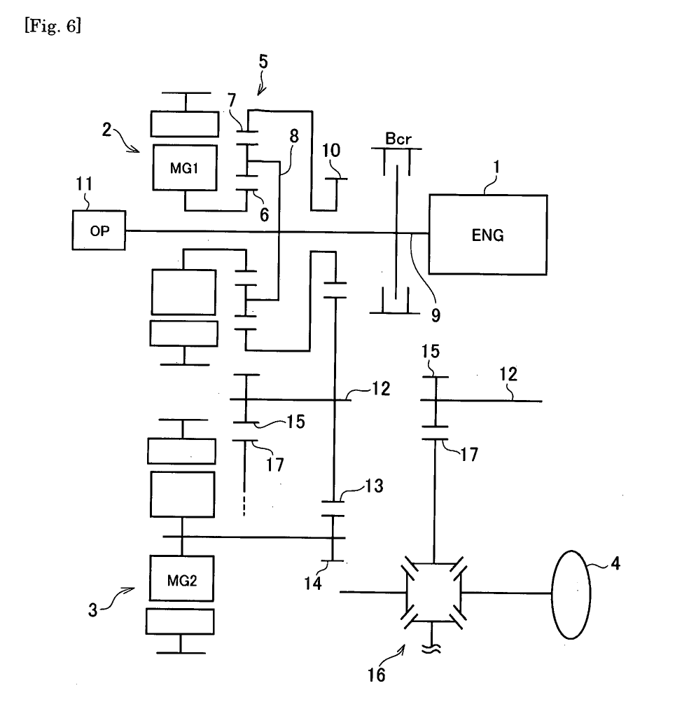

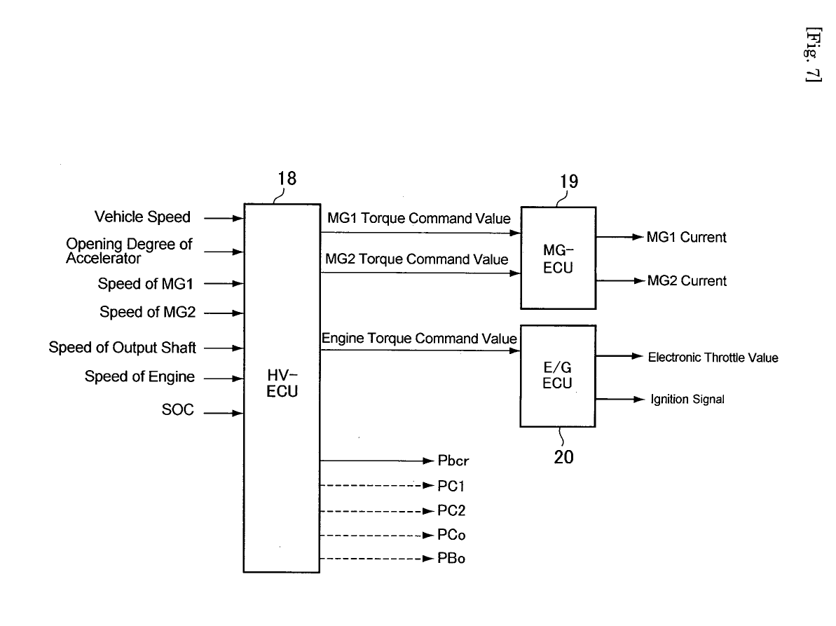

Turning to FIG. 6, there is shown another example of power train to which the control system of the present invention is applied. In the example shown in FIG. 6, a power of the engine 1 is distributed to the first motor-generator 2 side and the driving wheels 4 side, and the second motor-generator 3 is operated by the electric power generated by the first motor-generator 2 so that the driving wheels 4 is driven by the power of the second motor-generator 3. That is, so-called a “two-motor type”, or a “series/parallel type” hybrid drive unit is shown in FIG. 6. In this example, a single-pinion type planetary gear unit is disposed coaxially with the engine 1 to serve as a power distribution device 5. Specifically, the power distribution device 5 is adapted to perform a differential action among three rotary elements, and a sun gear 6 is connected with a rotor of the first motor-generator 2 disposed in the opposite side of the engine 1 across the power distribution device 5. A ring gear 7 is arranged concentrically with the sun gear 6, and a pinion gear(s) interposed between the sun gear 6 and the ring gear 7 while meshing therewith is/are supported by a carrier 8 while being allowed to rotate and revolve around the sun gear 6. The carrier 8 is connected with an output shaft 9 of the engine 1, and the ring gear 7 is connected with a drive gear 10 disposed between the engine 1 and the power distribution device 5. Thus, the carrier 8 serves as an input element of the power distribution device 5, and a brake Bcr is disposed between the drive gear 10 and the engine 1 so as to halt a rotation of the carrier 8. That is, since the carrier 8 is connected with the output shaft 9 of the engine 1, the brake Bcr halts a rotation of the engine 1. For example, a friction clutch engaged hydraulically or a dog clutch may be used as the brake Bcr. Accordingly, the brake Bcr serves as an engagement device of the present invention.

In order to lubricate the power distribution device 5, and to hydraulically control the power distribution device 5, an oil pump (OP) 11 is also connected with the output shaft 9 on the other side of the engine 1 to be driven by the engine 1.

A counter shaft 12 is arranged in parallel with a common rotational center axis of the power distribution device 5 and the first motor-generator 2, and a counter driven gear 13 meshing with the drive gear 10 is fitted onto the counter shaft 12 to be rotated integrally therewith. A diameter of the counter driven gear 13 is larger than that of the drive gear 10 so that a rotational speed is reduced, that is, torque is amplified during transmitting the torque from the power distribution device 5 to the counter shaft 12.

The second motor-generator 3 is arranged in parallel with the counter shaft 12 so that torque thereof may be added to the torque transmitted from the power distribution device 5 to the driving wheels 4. To this end, a reduction gear 14 connected with a rotor of the second motor-generator 3 is meshed with the counter driven gear 13. A diameter of the reduction gear 14 is smaller than that of the counter driven gear 13 so that the torque of the second motor-generator 3 is transmitted to the counter driven gear 13 or the counter shaft 12 while being amplified. According to such arrangement, a speed reduction ratio between the reduction gear 14 and the counter driven gear 13 can be increased, and mountability of the power train on a front-engine/front-drive vehicle can be improved.

In addition, a counter drive gear 15 is fitted onto the counter shaft 12 in a manner to be rotated integrally therewith, and the counter drive gear 15 is meshed with a ring gear 17 of a differential gear unit 16 serving as a final reduction device. In FIG. 6, however, a position of the differential gear unit 16 is displaced to the right side for the convenience of illustration.

In the power train shown in FIG. 6, each motor-generators 2 and 3 is also connected individually with an electric storage device such as a battery through a not shown controller such as an inverter. Therefore, those motor-generators 2 and 3 are individually switched between a motor and a generator by controlling a current applied thereto. Meanwhile, an ignition timing of the engine 1 and an opening degree of the throttle valve are controlled electrically, and the engine 1 is stopped and restarted automatically.

Those controls are executed by an electronic control unit, and a control system of the preferred example is shown in FIG. 7. The control system is comprised of a hybrid control unit (as will be called HV-ECU hereinafter) 18 for entirely controlling a running condition of the vehicle, a motor-generator control unit (as will be called MG-ECU hereinafter) 19 for controlling the motor-generators 2 and 3, and an engine control unit (as will be called E/G-ECU hereinafter) 20 for controlling the engine 1. Each control unit 18, 19 and 20 are individually composed mainly of a microcomputer configured to carry out a calculation based on input data and preinstalled data, and to output a calculation result in the form of a command signal. For example, a vehicle speed, an opening degree of the accelerator, a speed of the first motor-generator 2, a speed of the second motor-generator 3, a speed of the ring gear 7 (i.e., an output shaft speed), a speed of the engine 1, an SOC of the battery and so on are inputted to the HV-ECU 18. Meanwhile, the HV-ECU 18 is configured to output a torque command for the first motor-generator 2, a torque command for the second motor-generator 3, a torque command for the engine 1, a hydraulic command for the brake Bcr and so on. Given that the control system is applied to the power train shown in FIG. 4, the HV-ECU 18 optionally outputs a hydraulic command PC1 for the first clutch C1 and a hydraulic command PC2 for the second clutch C2. Further, the HV-ECU 18 additionally outputs a hydraulic command PC0 for an after-mentioned clutch C0 of a transmission unit 22, and a hydraulic command PB0 for an after-mentioned brake B0.

The torque command for the first motor-generator 2 and the torque command for the second motor-generator 3 are sent to the MG-ECU 19, and the MG-ECU 19 calculates current commands to be sent individually to the first motor-generator 2 and the second motor-generator 3 using those input data. Meanwhile, the torque command for the engine 1 is sent to the E/G-ECU 20, and the E/G-ECU 20 calculates a command to control an opening degree of the throttle valve and a command to control an ignition timing using those input data, and the calculated command values are individually sent to an electronic throttle valve and ignition device (not shown).

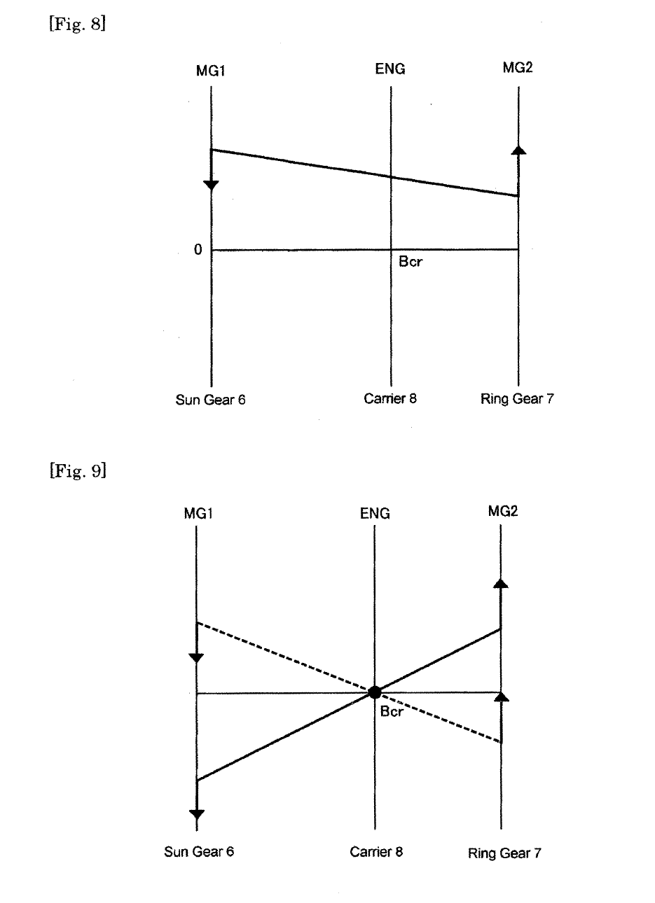

In the vehicle having the powertrain shown in FIG. 6, the driving mode may also be selected from the above-explained engine mode, dual-motor mode and single-motor mode. Torques and rotational speeds under each driving mode are shown in FIGS. 8 and 9. Under the engine mode, the engine 1 is operated in a manner to generate a power possible to achieve the required driving force while producing optimal fuel consumption. FIG. 8 is a nomographic diagram of the power distribution device 5. As can be seen from FIG. 8, under the engine mode, the torque of the engine 1 is applied to the carrier 8, and a resistance torque is applied to the ring gear 7. In this situation, if a negative torque (i.e., a reaction torque) of the first motor-generator 2 is applied to the sun gear 6 (that is, in the direction opposite to the direction of the engine torque), a torque of the ring gear 7 functioning as an output element is increased (in the forward direction). Given that the first motor-generator 2 is rotated in the forward direction (i.e., in the same direction as the engine 1), such negative torque of the first motor-generator 2 is generated by operating the first motor-generator 2 as a generator. Consequently, an electric power is generated by the first motor-generator 2, and the electric power thus generated is delivered to the second motor-generator 3 to operate the second motor-generator 3 as a motor. The torque generated by the second motor-generator 3 is added to the torque generated by the engine 1 and transmitted to the driving wheels 4. Thus, under the engine mode, the power of the engine 1 is distributed to the first motor-generator 2 side and the drive gear 10 side through the power distribution device 5, and the torque distributed to the drive gear 10 side is further transmitted to the differential gear unit 16 though the counter shaft 12. On the other hand, the power distributed to the first motor-generator 2 side is once converted into an electric power and then converted into a mechanical power again by the second motor-generator 3, and delivered to the differential gear unit 16 through the counter driven gear 13, the counter shaft 12 and so on.

FIG. 9 is a nomographic diagram showing torques under the driving mode for propelling the vehicle using at least any one of the motor-generators 2 and 3. For example, under the single-motor mode, the second motor-generator 3 is rotated in the forward direction, and the torque thereof is delivered to the driving wheels 4 through the counter shaft 12 to propel the vehicle in the forward direction. In this situation, a rotation of the engine 1 is halted by engaging the brake Bcr to avoid a power loss resulting from rotating the engine 1 concurrently. Consequently, the first motor-generator 2 connected with the sun gear 6 is rotated in the backward direction. Therefore, an energy regeneration can be achieved while establishing a braking force by also operating the first motor-generator 2 as a motor during reducing the speed.

Under the single motor-mode, the torque in the forward direction can be applied to the ring gear 7 by rotating the first motor-generator 2 backwardly by delivering the electric power thereto the from the battery. The forward torque thus generated is added to the torque of the second motor-generator 3 and delivered to the driving wheels 4. In this situation, the vehicle is propelled by both of the motor-generators 2 and 3, that is, the vehicle is driven under the dual-motor mode. As described, in the hybrid vehicle to which to the present invention is applied, the driving mode is selected from the engine mode, the single-motor mode and the dual motor mode, depending on the target power. The required driving force calculated based on an opening degree of the accelerator and a vehicle speed, or a predetermined coefficient calculated based on an opening degree of the accelerator and the required driving force may be employed as the target power. Those driving modes are determined to achieve the required driving force in an optimally energy efficient manner. Therefore, even if the vehicle runs within the dual-motor region II but frictional power loss or the like is increased, the single motor mode is selected. Given that the dual-motor mode is selected in the vehicle shown in FIG. 6, the power of the first motor-generator 2 is delivered through the power distribution device 5. The power distribution device 5 is, however, required to be lubricated by the oil, and viscosity of the lubricant oil is increased with a decrease in temperature. That is, a so-called “drag loss” is caused if the viscosity of the lubricant oil is too high. In order to avoid such power loss (i.e., deterioration in the energy efficiency), it is preferable to expand the single-motor region I in an upper direction in FIG. 5 by increasing an upper limit of the required driving force F, provided that the oil temperature is low. By contrast, it is preferable to expand the dual-motor region II in a lower direction in FIG. 5 by decreasing a lower limit of the required driving force F provided that the oil temperature is high.

As described, the selection of the driving mode between the single motor-mode and the dual-motor mode is basically made based on the required driving force and the vehicle speed, with reference to the map shown in FIG. 5. The map is basically prepared taking into consideration the electrical energy efficiency to control the motor-generators 2 and 3, but without considering mechanical factors. According to the present invention, therefore, the driving force control system is configured to make a selection of the driving mode between the single motor-mode and the dual-motor mode also taking into consideration the power losses caused by the mechanical factors while running the vehicle.

Referring now to FIG. 1, there is shown a flowchart of a preferred control example, and the HV-ECU 18 is configured to repeat the control example shown in FIG. 1 at predetermined short intervals, as long as the main switch of the hybrid vehicle is turned on. The control shown in FIG. 1 is carried out upon satisfaction of a condition or a judgment to power the vehicle by at least one of the motor-generators 2 and 3 without using the engine 1. That is, the control shown in FIG. 1 is started when the driving condition of the vehicle governed by the required driving force F and the vehicle speed V enters into any of the single-motor region I, the dual-motor region II and the dual-motor requiring region III. To this end, the required driving force F, the opening degree of the accelerator and the vehicle speed V are detected on a constant basis. According to the control shown in FIG. 1, first of all, it is determined whether or not the current driving condition falls within the dual-motor requiring region III based on the detected required driving force F and vehicle speed V, with reference to the map shown in FIG. 5 (at step S1).

If the required driving force F at current vehicle speed V is not especially large so that the answer of step S1 is NO, an oil temperature is detected (at step S2). Specifically, in the powertrain shown in FIG. 5, a temperature of the lubricant oil for lubricating the power distribution device 5 is detected. Basically, the temperature of the lubricant oil is detected by a sensor on a constant basis so that the detection value of the sensor can be used at step S2. That is, at step S2, the oil temperature is detected to judge an occurrence of the drag loss at torque transmitting points such as the power distribution device 5. As described, the viscosity of the lubricant oil is increased with decreasing temperature thereof, and the drag loss is increased thereby. By contrast, the viscosity of the lubricant oil is decreased with increasing temperature thereof, and the drag loss is reduced thereby.

Then, the operating regions are determined (at step S3). Specifically, the single-motor region I and the dual-motor region II are determined in a manner such that the required driving force F is achieved while optimizing the energy efficiency. As described, the brake Bcr serving as the engagement mechanism of the invention is engaged under the dual-motor mode, therefore, the energy consumed to engage the brake Bcr is also counted as the power loss to establish the dual-motor mode. Specifically, given that a hydraulic frictional clutch is used as the brake Bcr, a torque transmitting capacity thereof is changed responsive to hydraulic pressure applied thereto. Meanwhile, a torque applied to the brake Bcr is changed in accordance with an output torque of the first motor-generator 2 and a gear ratio of the power distribution device 5 as the planetary gear mechanism (i.e., a ratio between numbers of tooth of the sun gear 6 and the ring gear 7). Accordingly, the hydraulic pressure to engage the brake Bcr may be determined based on the output torque of the first motor-generator 2 (or a current value applied thereto) or the like. As also described, the engine 1 is stopped under the dual-motor mode. Therefore, the hydraulic pressure to engage the brake Bcr is established by driving a not shown electric oil pump, and an electric power to be consumed by the electric oil pump may be calculated based on a value of the hydraulic pressure or a required amount of the oil. Thus, the energy consumed by engaging the brake Bcr (i.e., a power loss) can be calculated based on the output torque of the first motor-generator 2 or the current value applied thereto under the dual-motor mode. If a friction clutch or a dog clutch adapted to be engaged by an electromagnetically is used as the brake Bcr, electric current is also applied to the brake Bcr. In this case, therefore, a required current (i.e., the energy consumption) may also be calculated based on the torque applied to the brake Bcr or the output torque of the first motor-generator 2.

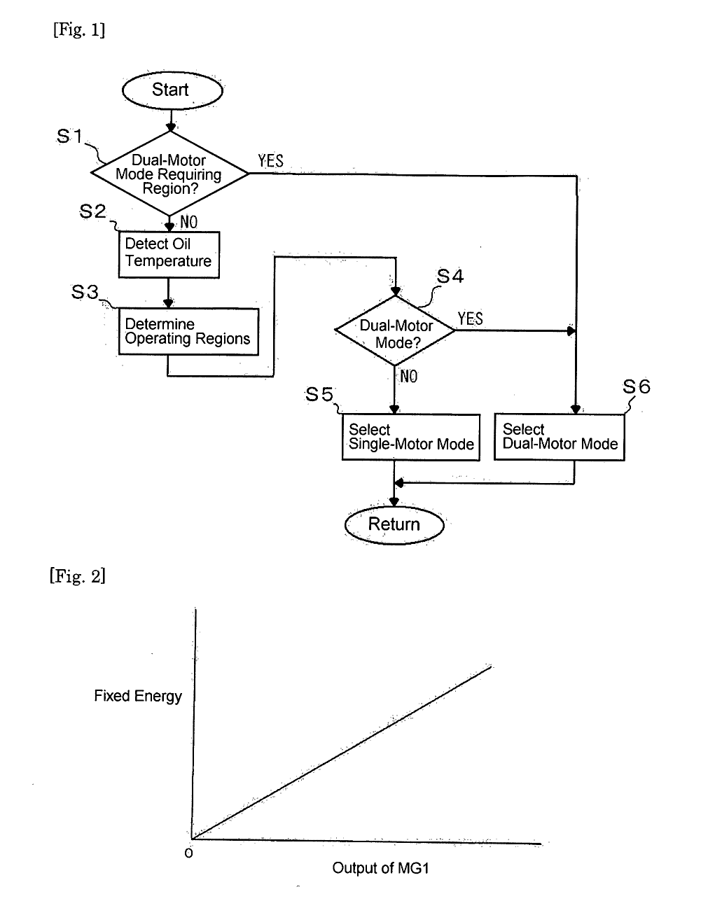

That is, a relation between the output of the first motor-generator 2 and the energy for engaging the brake Bcr (i.e., a fixed energy) is governed by a structure and a capacity of the clutch employed as the brake Bcr, a structure of the power distribution device 5 and so on. As shown in FIG. 2, such relation may be determined in advance. As can be seen from FIG. 2, the energy to be consumed by engaging the brake Bcr is increased with an increase in the output of the first motor-generator 2.

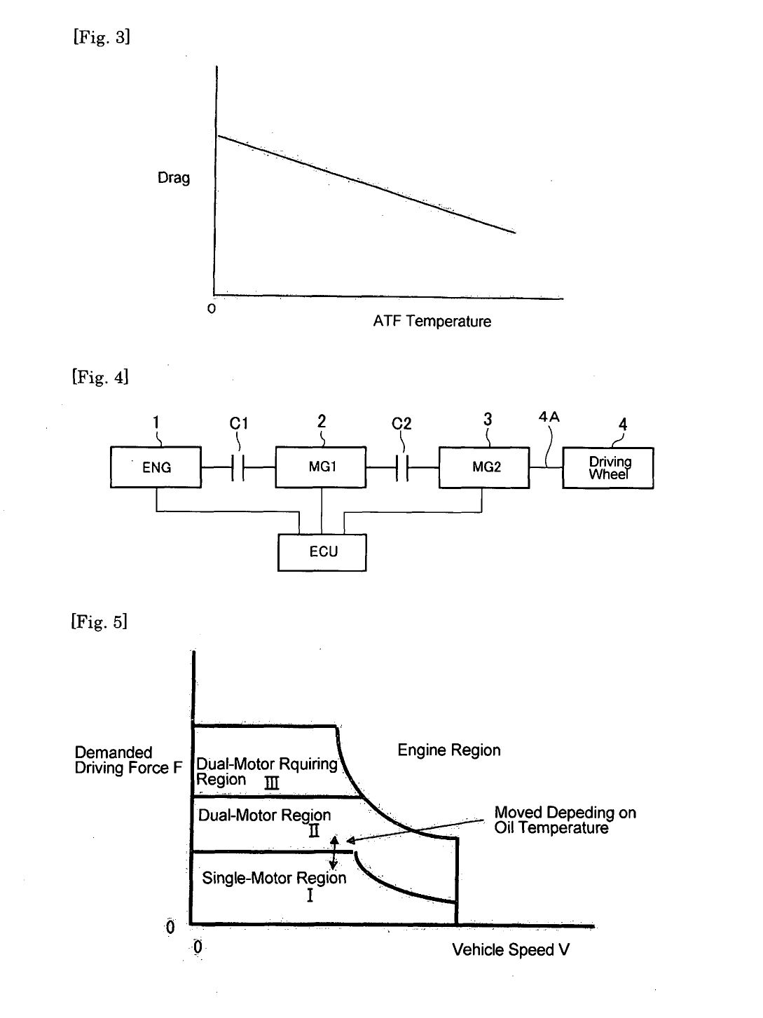

As described, under the dual-motor mode, the power of the first motor-generator 2 is outputted from the drive gear 10 through the power distribution device 5, and in this situation, a power loss is caused depending on viscosity of the lubricant oil delivered to the distribution device 5. Such power loss with respect to the oil temperature may also be determined in advance based on an experimentation or a simulation. For example, a relation between the drag loss and the oil temperature (ATF temperature) may be expressed as the graph shown in FIG. 3. As can be seen from FIG. 3, the power loss is reduced with a rise in the oil temperature. Therefore, as shown in FIG. 5, the single-motor region I is expanded by increasing an upper limit of the required driving force F given that the oil temperature is low, and the dual-motor region II is expanded by decreasing a lower limit of the required driving force F given the oil temperature is high.

At step S3, therefore, the single-motor region I and the dual-motor region II are determined based on an amount of the energy to be consumed by engaging the brake Bcr, an energy loss caused in the power distribution device 5, and a reduction amount of the energy consumption to be achieved by shifting from the single-motor mode to the dual motor-mode. Therefore, the driving mode is to be selected from the single-motor region I and the dual-motor region II thus determined depending on the current driving condition. Specifically, the single-motor mode is selected provided that a total increment of the energy consumption including the energy consumption resulting from engaging the brake Bcr to establish the dual-motor mode (that is, the energy loss) is larger than a decrement of a consumption of the electrical energy achieved by shifting from the single-motor mode to the dual-motor mode (i.e., an energy gain). Consequently, the energy efficiency will not be degraded to establish the dual-motor mode.

Thus, at step S3, the operating regions are determined taking into consideration the increment of the energy consumption (i.e., the energy loss) resulting from engaging the brake Bcr. Then, it is determined whether or not the current the current driving condition falls within the dual-motor region II (at step S4). As described, the energy consumption resulting from engaging the brake Bcr is considered as the power loss. Therefore, there is a tendency to expand the single-motor region I by increasing an upper limit of the required driving force F so that the driving condition of the vehicle readily falls within the single-motor region I. That is, the answer of step S4 would be NO in more cases. If the answer of step S4 is NO, the single-motor mode is selected (at step S5), and the routine is returned. Specifically, the brake Bcr is disengaged while stopping the engine 1 and the first motor-generator 2, and the second motor-generator 3 is operated to power the vehicle. In this case, the energy will not be consumed to engage the brake Bcr. Therefore, although the energy efficiency (i.e., a fuel economy or an electric economy) may be deteriorated slightly to operate the second motor-generator 3 in a manner to propel the vehicle only by the power thereof, the energy efficiency is still better than that under the dual motor-mode.

By contrast, if the answer of step S4 is YES, that is, if the driving condition of the vehicle falls within the dual-motor region II, the dual-motor mode is selected (at step S6), and the routine is returned. Specifically, the brake Bcr is engaged while stopping the engine 1, and both of the motor-generators 2 and 3 are operated to generate torques for propelling the vehicle. In this case, the energy is consumed to engage the brake Bcr. However, the electrical energy efficiency is improved by thus shifting from the single-motor mode to the dual-motor mode thereby reducing the energy consumption. The decrement of the energy consumption thus achieved exceeds the increment of the energy consumption resulting from engaging the brake Bcr. Therefore, the energy efficiency (i.e., the fuel economy or the electric economy) can be improved in comparison with that to be achieved under the single-motor mode.

In addition, if the answer of step S1 is YES, that is if the driving condition of the vehicle falls within the dual-motor requiring region III, the routine advances directly to step S6 to select the dual-motor mode.

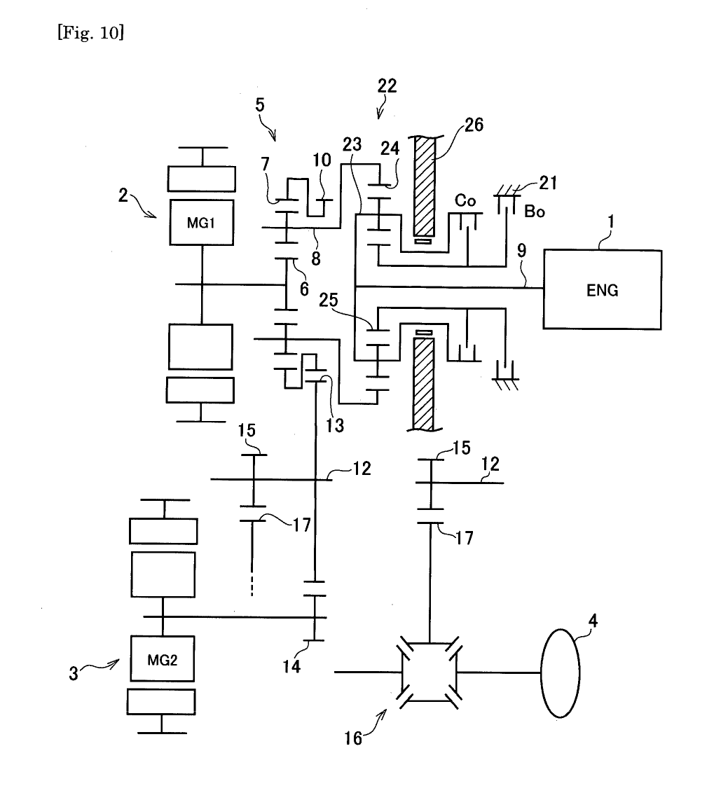

The control system of the present invention may also be applied to a powertrain of a hybrid vehicle other than that shown in FIG. 6. A partial modification example of the powertrain to which the present invention is applied is shown in FIG. 10. In the powertrain shown in FIG. 10, a transmission 22 is interposed between the engine 1 and the power distribution device 5. The transmission 22 is comprised of a single pinion planetary gear mechanism, and adapted to shift a gear stage between a direct drive stage (i.e., a low stage) and a speed increasing stage (i.e., an overdrive stage (O/D) or a high stage). In the transmission 22, a carrier 23 is connected with the output shaft 9 of the engine 1, and a ring gear 24 is connected with the carrier 8 of the power distribution device 5 in a manner to be rotated integrally therewith. In this example, a clutch C0 is disposed between a sun gear 25 and the carrier 23 to connect those elements selectively, and a brake B0 is disposed to halt the sun gear 25 selectively. For example, a hydraulically engaged frictional engagement device may be employed as each of the clutch C0 and brake B0. In the example shown in FIG. 10, accordingly, those clutch C0 and brake B0 serve as the engagement device of the present invention, instead of the brake Bcr of the example shown in FIG. 6.

The clutch C0 and the brake B0 are preferably disposed closer to the engine 1 than the transmission 22 across a bulkhead 22 as a part of a housing so that oil paths for delivering/discharging the oil to/from the clutch C0 and the brake B0 are formed in the bulkhead 26. In addition, only a slight modification is required to realize the powertrain shown in FIG. 10 based on the conventional hybrid powertrain. Therefore, the powertrain shown in FIG. 10 can be assembled or manufactured easily. The remaining structures are similar to those in FIG. 6, therefore, further explanation for the remaining elements will be omitted by allotting common reference numerals to FIG. 10.

In the transmission 22, the direct drive stage (i.e., the low stage) is established by engaging the clutch C0 to connect the sun gear 25 and the carrier 23, and under the direct drive stage, the planetary gear mechanism is rotated integrally so that the torque is transmitted without increasing or decreasing the speed. In this situation, the transmission 22 is halted entirely by additionally engaging the brake B0 so that rotations of the carrier 8 and the engine 1 are stopped. By contrast, the sun gear 25 serves as a fixing element and the carrier 23 serves as an input element given that only the brake B0 is engaged. In this situation, the ring gear 24 serves as an output element and rotated in the same direction as the carrier 23 at a speed higher than that of the carrier 23. Consequently, the transmission 22 serves as a speed increasing device, that is, the O/D stage (i.e., the high stage) is established. Under the O/D stage, the torque of the engine 1 is applied to the carrier 8 while being decreased in accordance with a speed ratio of the transmission 22. The torque to be generated by the first motor-generator 2 can be reduced in comparison with the example shown in FIG. 6. Additionally, although the transmission 22 is disposed in an upstream side of the power distribution device 5 in the example shown in FIG. 10, the remaining strictures in the downstream side of the power distribution device 5 are similar to those of the example shown in FIG. 6. Therefore, the single-motor mode and the dual-motor mode may also be established in the example shown in FIG. 10.

Statuses of the clutch C0, the brake B0 and the motor generators 2 and 3 under each driving mode are shown in FIG. 11. In FIG. 11, “EV” represents the motor running mode. As can be seen from FIG. 11, under the single-motor mode, both of the clutch C0 and the brake B0 are disengaged, the first motor-generator 2 serves as a generator, and the second motor-generator 3 serves as a motor. In this situation, the first motor-generator 2 may also be idled. Under the single-motor mode, an engine braking can be applied by engaging both of the clutch C0 and the brake B0 to halt the carrier 8 of the power distribution device 5.

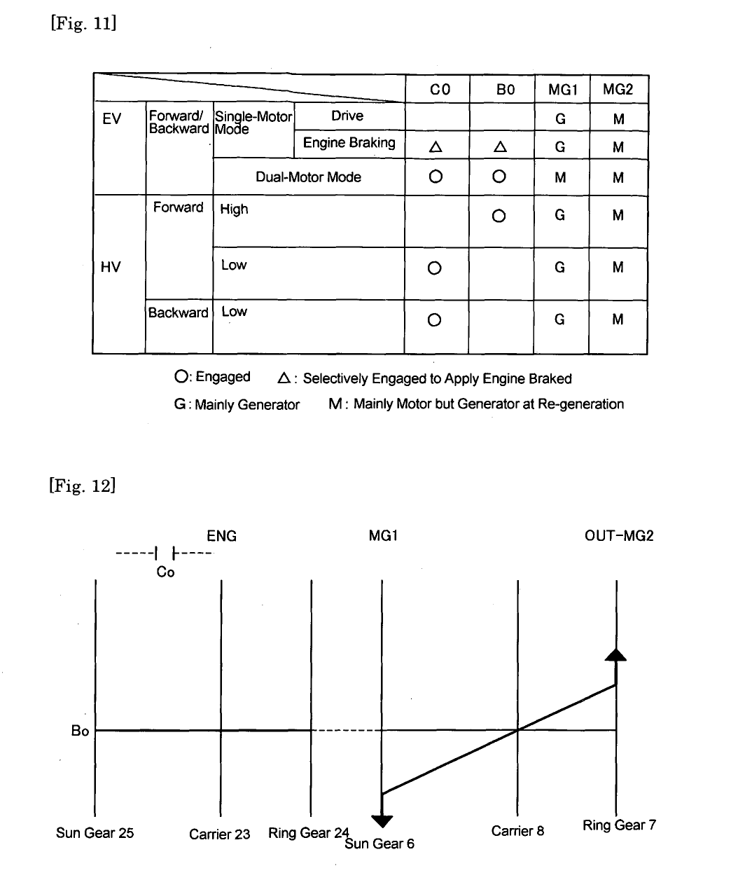

In turn, under the dual-motor mode, both of the motor-generators 2 and 3 are operated as motors. In this case, both of the clutch C0 and the brake B0 are engaged to halt the carrier 8 thereby delivering the torque of the first motor-generator 2 from the drive gear 10 to the counter driven gear 13. That is, as shown in FIG. 12, the power distribution device serves as a speed reducing device, and the torque of the first motor-generator 2 is delivered from the drive gear 10 to the counter driven gear 13 while being amplified.

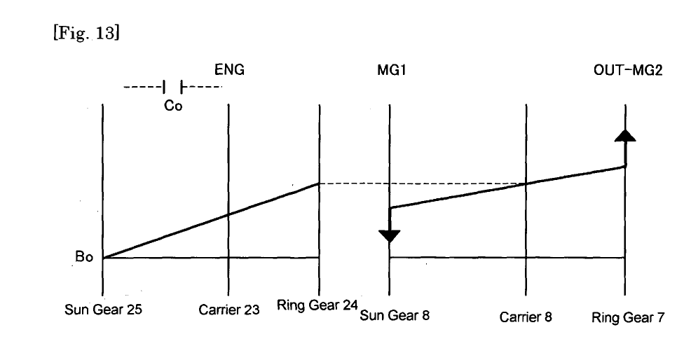

Meanwhile, in FIG. 11, “HV” represents the hybrid mode where the engine is operated. Given that the vehicle runs at a medium to high speed under the HV mode, the O/D stage is established in the transmission 22 by disengaging the clutch C0 while engaging the brake B0 as shown in FIG. 13. As described, the rotational speed of the engine 1 is controlled by the first motor-generator 2 in an optimally fuel efficient manner. In this situation, the first motor-generator 2 serves as a generator, and the second motor-generator 3 is driven as a motor to generate a driving force by the electric power generated by the first motor-generator 2. By contrast, when a large driving force is required, for example, when the vehicle speed is low and an opening degree of the accelerator is large, the direct drive stage (i.e., the low stage) is established in the transmission 22 by engaging the clutch C0 while disengaging the brake B0, and the transmission 22 is rotated integrally. In this situation, the first motor-generator 2 remains as a generator and the second motor-generator 3 remains as a generator. In case of propelling the vehicle in the backward direction by operating the engine 1, the direct drive stage (i.e., the low stage) is also established in the transmission 22 while operating the first motor-generator 2 as a generator and the second motor-generator 3 as a motor. In this situation, the driving wheel is rotated in the backward direction by controlling rotational directions and speeds of the motor-generators 2 and 3.

Thus, according to the foregoing preferred example, operating regions of the motors are determined taking into account the energy consumption rate or the energy consumption amount, and the driving mode is selected based on the operating region where the current running condition of the vehicle belongs. Therefore, the present invention may also be applied to an electric vehicle to improve the energy efficiency while achieving a required driving force. In addition, the present invention should not be limited o the foregoing examples. For example, the control system of the present invention may be directly select the single-motor mode or the dual-motor mode based on the degrading factors of the energy efficiency such as the energy consumption for engaging the engagement device, the oil temperature etc.

1. A driving force control system for a vehicle that is applied to a vehicle having at least two torque generating rotary devices serving as a prime mover, and that establishes a single motor-mode where the vehicle is propelled by a power of any one of the rotary devices and a dual motor-mode where the vehicle is propelled by powers of both of the rotary devices,
the driving force control system is configured to select the single-motor mode rather than the dual-motor mode provided that an increment of an energy consumption to establish the dual-motor mode is larger than a decrement of the energy consumption to be achieved by propelling the vehicle under the dual-moor mode, under a driving condition where a required driving force can be achieved by either the single-motor mode or the dual-motor mode.

2. The driving force control system for a vehicle as claimed in claim 1,
wherein the vehicle is comprised of a power distribution device adapted to perform a differential action at least among a first rotary element, a second rotary element to which a torque of a first rotary device of the two torque generating rotary devices is inputted, and a third rotary element serving as an output element to which a torque of a second rotary device of the two torque generating rotary devices is inputted; and
the single-motor mode includes a driving mode for propelling the vehicle by a power generated by the second rotary device.

3. The driving force control system for a vehicle as claimed in claim 1, further comprising:
an engagement device that is engaged to establish the dual-motor mode; and wherein the increment of the energy consumption to establish the dual-motor mode includes an energy consumed to engage the engagement device.

4. The driving force control system for a vehicle as claimed in claim 3,
wherein the prime mover is further comprised of an engine; and
wherein the engagement device is adapted to halt a rotation of the engine by being engaged.

5. The driving force control system for a vehicle as claimed in claim 3,
wherein the power distribution device is lubricated by lubricant whose viscosity is changed depending on a temperature; and
wherein the increment of the energy consumption to establish the dual-motor mode includes the energy consumed to engage the engagement device, and an amount of energy loss resulting from a reduction in a torque of the first rotary device occurs in the torque distribution device.

6. The driving force control system for a vehicle as claimed in claim 3,
wherein the first rotary device is connected with an output shaft for delivering the torque to driving wheels;
wherein the second rotary device is connected with the first rotary device through the engagement device; and
wherein the engine is connected with the second rotary device through a clutch.

7. The driving force control system for a vehicle as claimed in claim 1, wherein the torque generating rotary device includes a motor or a motor-generator.

8. The driving force control system for a vehicle as claimed in claim 3, wherein the engagement device includes a friction clutch or a dog clutch that is engaged hydraulically or electromagnetically.
